(19) United States
(12) Patent Application Publication
(10) Pub. No.: US 2023/0325474 A1
(43) Pub. Date: Oct. 12, 2023

(54) INFORMATION PROCESSING APPARATUS, INFORMATION PROCESSING METHOD, AND NON-TRANSITORY RECORDING MEDIUM

(71) Applicant: Ken Kubota, Kanagawa (JP)

(72) Inventor: Ken Kubota, Kanagawa (JP)

(73) Assignee: Ricoh Company, Ltd., Tokyo (JP)

(21) Appl. No.: 18/184,878

(22) Filed: Mar. 16, 2023

(30) Foreign Application Priority Data
Mar. 23, 2022 (JP) 2022-046674

(51) Int. Cl. G06F 21/79; G06F 21/10

(52) U.S. Cl. CPC G06F 21/10; G06F 21/79

(57) ABSTRACT

An information processing apparatus includes a memory, a connection port to connect to an external recording medium including a first recording medium and a second recording medium, and circuitry. The circuitry is to store, in the memory, data and license information of the data read from the first recording medium connected to the connection port, invalidate the license information stored in the first recording medium, store the data and the license information read from the memory in the second recording medium that is connected to the connection port after the first recording medium has been disconnected from the connection port, and invalidate the license information stored in the memory.

### CROSS-REFERENCE TO RELATED APPLICATIONS

This patent application is based on and claims priority pursuant to 35 U.S.C. §119(a) to Japanese Patent Application No. 2022-046674, filed on Mar. 23, 2022, in the Japan Patent Office, the entire disclosure of which is hereby incorporated by reference herein.

### BACKGROUND

### Technical Field

The present disclosure relates to an information processing apparatus, an information processing method, and a non-transitory recording medium.

### Related Art

Various information processing apparatuses including an image forming apparatus are capable of executing applications.

Many applications are installed in advance in an auxiliary storage device included in an information processing apparatus to be activated on the information processing apparatus, whereas some applications are installed in an external recording medium such as a secure digital (SD) card and can be activated only when the external recording medium is connected to the information processing apparatus.

When such an external recording medium is released for each application, users cannot use a plurality of applications simultaneously (concurrently) unless a plurality of external recording media is connected to an information processing apparatus at the same time. Such a situation is inconvenient for the users since the number of slots for connecting the plurality of external recording media is limited in the information processing apparatus. To address such an inconvenience, there is a technique for collectively storing, in one external recording medium, the plurality of applications individually stored in the plurality of external recording media. For example, there is known a technique for moving an application and license information of the application from one external recording medium to another external recording medium.

### SUMMARY

In one aspect, an information processing apparatus includes a memory, a connection port to connect to an external recording medium including a first recording medium and a second recording medium, and circuitry. The circuitry is to store, in the memory, data and license information of the data read from the first recording medium connected to the connection port, invalidate the license information stored in the first recording medium, store the data and the license information read from the memory in the second recording medium that is connected to the connection port after the first recording medium has been disconnected from the connection port, and invalidate the license information stored in the memory.

In another aspect, an information processing method includes storing, in a memory, data and license information of the data read from a first recording medium connected to a connection port of an information processing apparatus, invalidating the license information stored in the first recording medium, storing the data and the license information read from the memory in a second recording medium that is connected to the connection port after the first recording medium has been disconnected from the connection port, and invalidating the license information stored in the memory.

In another aspect, a non-transitory recording medium stores a plurality of program codes which, when executed by one or more processors, causes the processors to perform a method. The method includes storing, in a memory, data and license information of the data read from a first recording medium connected to a connection port of an information processing apparatus, invalidating the license information stored in the first recording medium, storing the data and the license information read from the memory in a second recording medium that is connected to the connection port after the first recording medium has been disconnected from the connection port, and invalidating the license information stored in the memory.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a block diagram illustrating an example of a hardware configuration of an image forming apparatus according to an embodiment of the present disclosure;

FIG. 2 is a block diagram illustrating an example of a functional configuration of the image forming apparatus according to an embodiment of the present disclosure;

FIG. 3 is a flowchart illustrating an example of processing for moving data from a source secure digital (SD) card to the image forming apparatus according to an embodiment of the present disclosure;

FIG. 4 is a sequence chart illustrating an example of the processing for moving the data from the source SD card to the image forming apparatus according to an embodiment of the present disclosure;

FIG. 5 is a flowchart illustrating an example of processing for moving data from the image forming apparatus to a destination SD card according to an embodiment of the present disclosure;

FIG. 6 is a sequence chart illustrating an example of the processing for moving the data from the image forming apparatus to the destination SD card according to an embodiment of the present disclosure;

FIG. 7 is a flowchart illustrating an example of processing for cancelling the movement of the data from the source SD card to the image forming apparatus according to an embodiment of the present disclosure; and

FIG. 8 is a sequence chart illustrating an example of the processing for cancelling the movement of the data from the source SD card to the image forming apparatus according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

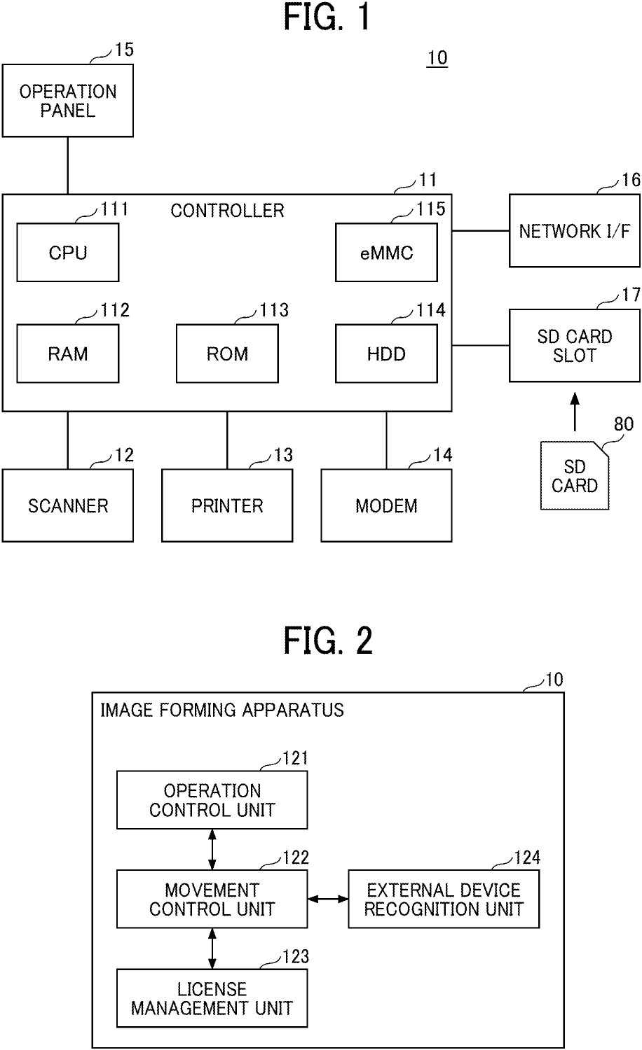

A description is given below of an embodiment of the present disclosure with reference to the accompanying drawings. FIG. 1 is a block diagram illustrating an example of a hardware configuration of an image forming apparatus 10 according to the present embodiment. As illustrated in FIG. 1, the image forming apparatus 10 includes hardware resources, such as a controller 11, a scanner 12, a printer 13, a modem 14, a control panel 15, a network interface (I/F) 16, and a secure digital (SD) card slot 17.

The controller 11 includes a central processing unit (CPU) 111, a random access memory (RAM) 112, a read only memory (ROM) 113, a hard disc drive (HDD) 114, and an embedded MultiMediaCard (eMMC) 115. The ROM 113 stores various programs and data used by the programs. The RAM 112 is used as a memory area to which a program is loaded and used as a work area for executing a loaded program. The CPU 111 executes a program loaded to the RAM 112 to implement various functions. The HDD 114 stores programs and various data used by the programs. The eMMC 115 is an example of a memory used for the movement of data between SD cards 80 in the present embodiment.

The scanner 12 is hardware (an image reading device) that scans a document to obtain image data. The printer 13 is hardware (a printing device) that forms an image on a sheet in accordance with print data. The modem 14 is hardware for connecting to a telephone line and is used for transmitting and receiving image data by facsimile communication. The control panel 15 is hardware that includes an input device such as keys or buttons for receiving a user input and a display device such as a liquid crystal panel. The liquid crystal panel may have a touch panel function. In this case, the liquid crystal panel also implements a function of an input device. The network I/F 16 is hardware that connects the image forming apparatus 10 to a wired or wireless network, such as a local area network (LAN). The SD card slot 17 is a connection port for the SD cards 80. As used herein, the term “connected/coupled” includes both direct connections and connections in which there are one or more intermediate connecting elements. In the image forming apparatus 10, not only the programs stored in the ROM 113 but also the programs stored in the SD cards 80 that are examples of an external recording medium may be loaded to the RAM 112 for execution. In addition or in alternative to an SD card 80, any other suitable recording medium may be used, such as a compact disk read only memory (CD-ROM) or a universal serial bus (USB) memory. In other words, the type of recording medium corresponding to the SD card 80 is not limited to a specific type. In this case, any other suitable hardware is used as the connection port in alternative to the SD card slot 17 depending on the type of recording medium. In the present embodiment, it is assumed that the image forming apparatus 10 includes only one SD card slot 17.

FIG. 2 is a block diagram illustrating an example of a functional configuration of the image forming apparatus 10 according to the present embodiment. As illustrated in FIG. 2, the image forming apparatus 10 includes an operation control unit 121, a movement control unit 122, a license management unit 123, and an external device recognition unit 124. Each of the above-mentioned functional units is implemented by processing executed by the CPU 111 according to one or more programs installed on the image forming apparatus 10.

The operation control unit 121 receives an input performed by an operator of the image forming apparatus 10 and displays (outputs) information to be notified of the operator on the control panel 15. The operation control unit 121 transmits an instruction corresponding to the input performed by the operator to the movement control unit 122. The operator refers to a person who operates the image forming apparatus 10 to move an application stored in one SD card (hereinafter referred to as a “source SD card”) to another SD card (hereinafter referred to as a “destination SD card”) in which another application is stored. In the present embodiment, an application includes a group of data related to the execution of the application (hereinafter referred to as “application data”) and license information related to the application. Accordingly, the movement of an application refers to the movement of application data and license information. By moving a plurality of applications from a plurality of source SD cards to a destination SD card, the plurality of applications is collectively stored in the destination SD card. In the present embodiment, only an SD card that has been licensed in advance by an application vendor can be used for activating an application. That is, only when such a licensed SD card is connected to the image forming apparatus 10, the application stored in the SD card can be activated on the image forming apparatus 10. This is because the image forming apparatus 10 verifies whether the SD card is licensed when the application is activated. In a case where the SD card is not licensed, the image forming apparatus 10 rejects the activation of the application. Therefore, the destination SD card needs to be an SD card distributed at the time of purchase of an application that is different from an application subjected to movement.

The movement control unit 122 controls processing relating to the movement of an application from the source SD card to the destination SD card. First, in a state where the source SD card is connected to the image forming apparatus 10 (a state where the source SD card is inserted into the SD card slot 17), the movement control unit 122 controls processing for moving application data and license information stored in the source SD card to a memory (the eMMC 115 in the present embodiment) included in the image forming apparatus 10. Next, in a state where the destination SD card is connected to the image forming apparatus 10 (a state where the destination SD card is inserted into the SD card slot 17), the movement control unit 122 controls processing for moving the application data and the license information stored in the eMMC 115 to the destination SD card. That is, the movement control unit 122 uses the eMMC 115 as a temporary storage area for the application to move the application from the source SD card to the destination SD card using only one SD card slot 17.

In response to a request from the movement control unit 122, the license management unit 123 moves the license information from the source SD card to the eMMC 115 and moves the license information from the eMMC 115 to the destination SD card.

The external device recognition unit 124 detects that an SD card has been connected to the image forming apparatus 10 (inserted into the SD card slot 17), and transmits a notification of the state of the SD card to the movement control unit 122. The external device recognition unit 124 also detects, for example, damage to an SD card, and transmits a notification that the SD card is damaged to the movement control unit 122.

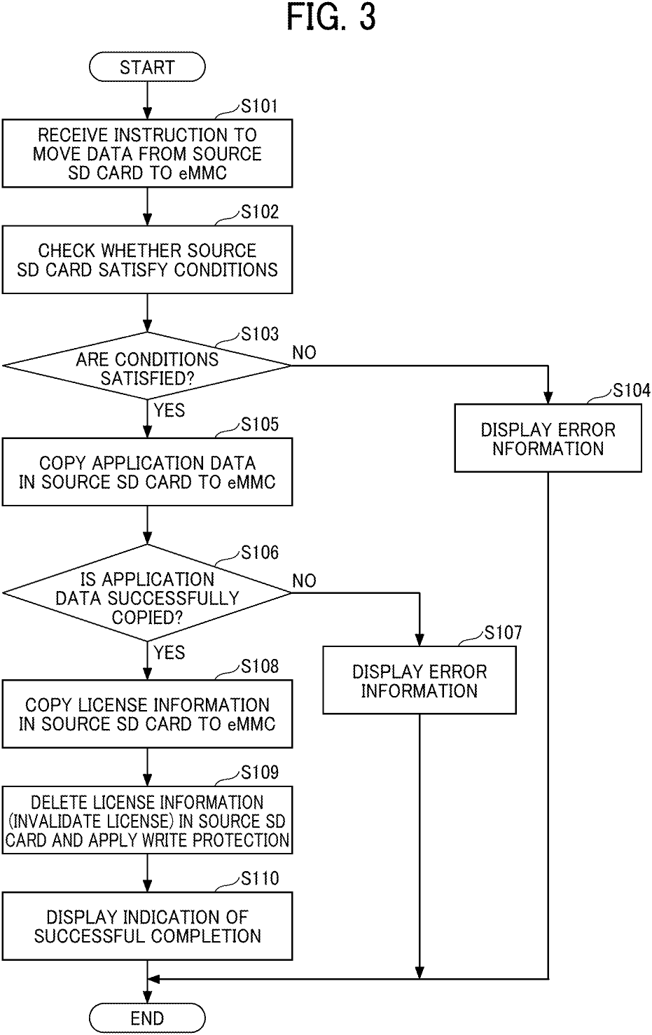

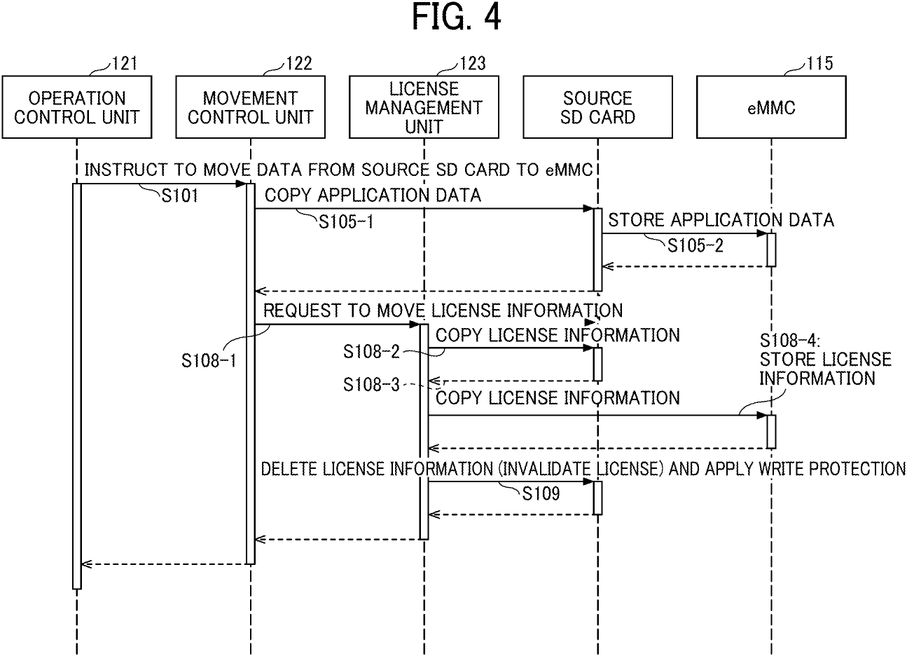

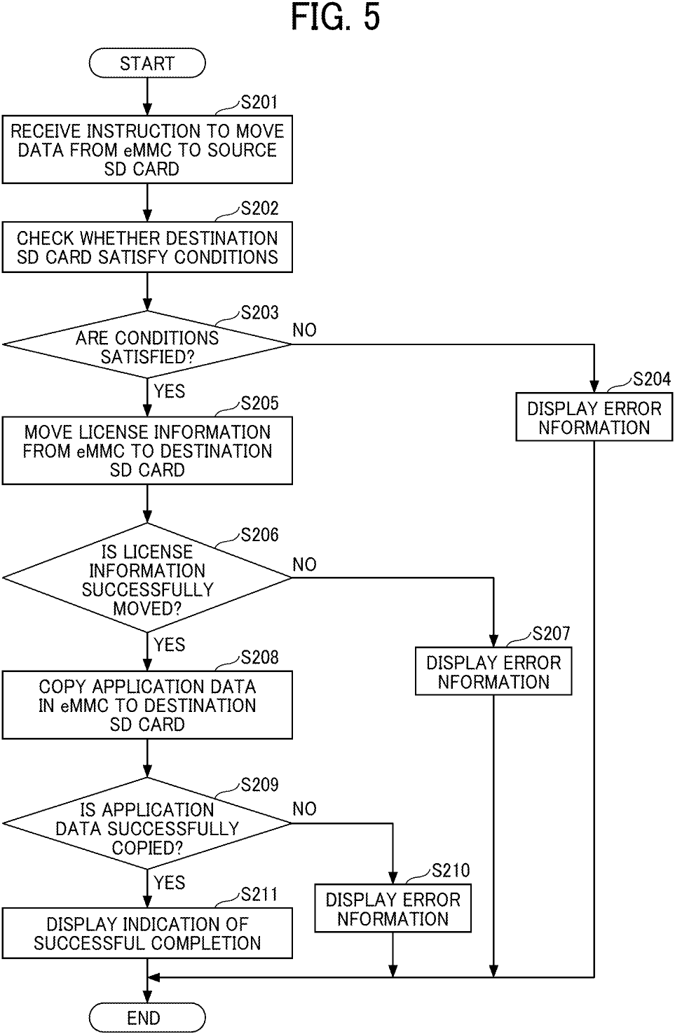

A description is given below of the processing performed by the image forming apparatus 10. FIG. 3 is a flowchart illustrating an example of processing for moving data from a source SD card to the image forming apparatus 10 according to the present embodiment. FIG. 4 is a sequence chart illustrating an example of the processing for moving the data from the source SD card to the image forming apparatus 10 according to the present embodiment. FIGS. 3 and 4 are diagrams illustrating the same processing in different manners. In both drawings, the same or corresponding steps are denoted by the same step numbers.

Prior to the start of the processing illustrated in each of FIGS. 3 and 4, the operator of the image forming apparatus 10 inserts the source SD card into the SD card slot 17. The operator is, for example, a service engineer of the image forming apparatus 10.

In step S101, the movement control unit 122 receives an instruction to move data from the source SD card to the eMMC 115 from the operation control unit 121 that has received the instruction from the operator.

Subsequently, the movement control unit 122 checks whether the source SD card satisfies conditions determined in advance (step S102). For example, the movement control unit 122 checks whether the source SD card is inserted into the SD card slot 17, whether the license information is stored in the source SD card, and whether valid (legitimate) application data is stored in the source SD card. The movement control unit 122 inquires the external device recognition unit 124 to check whether the source SD card is inserted into the SD card slot 17.

In a case where any one of the conditions is not satisfied (NO in step S103), the operation control unit 121 displays (outputs) error information indicating that the condition is not satisfied on the control panel 15 (step S104), and ends the processing.

In a case where all of the conditions are satisfied (YES in step S103), the movement control unit 122 copies (stores) the application data stored in the source SD card inserted into the SD card slot 17 to (in) the eMMC 115 (step S105).

In a case where the copying of the application data is not successfully completed (NO in step S106), the operation control unit 121 displays error information indicating that the copying of the application data is not successfully completed on the control panel 15 (step S107), and ends the processing. For example, when the capacity of the eMMC 115 is insufficient or when data having the same file name as the file name of the data to be copied is already stored in the eMMC 115, the copying of the application data fails.

In a case where the copying of the application data is successfully completed (YES in step S106), the movement control unit 122 copies (stores) the license information stored in the source SD card to (in) the eMMC 115 (step S108). More specifically, the movement control unit 122 requests the license management unit 123 to move the license information from the source SD card to the eMMC 115 (step S108-1 in FIG. 4). The license management unit 123 copies the license information from the source SD card (steps S108-2 and S108-3 in FIG. 4). The license management unit 123 stores the license information in the eMMC 115 (step S108-4).

The license management unit 123 invalidates the license information stored in the source SD card and applies write protection to the source SD card to disable writing to the source SD card (step S109). The invalidation of the license information stored in the source SD card is executed, for example, by deleting the license information stored in the source SD card. The reason for applying the write protection to the source SD card is to prohibit the use of the source SD card for another purpose after the application data and the license information are copied from the source SD card to the eMMC 115.

The operation control unit 121 displays (outputs) information indicating successful completion on the control panel 15 (step S110). The information includes, for example, a disconnection request of the source SD card (a request to disconnect the source SD card from the SD card slot 17) and a connection request of the destination SD card (a request to insert the destination SD card into the SD card slot 17).

Therefore, the operator disconnects the source SD card from the SD card slot 17 included in the image forming apparatus 10 and inserts the destination SD card into the SD card slot 17. In this state, the data (the application data and the license information) stored in the eMMC 115 is moved to the destination SD card.

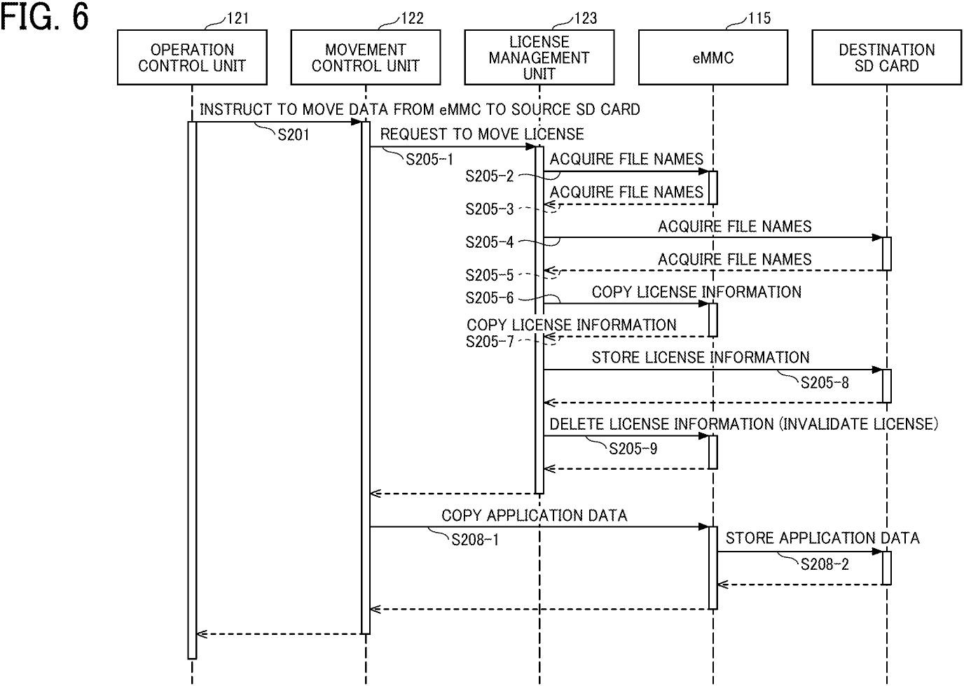

FIG. 5 is a flowchart illustrating an example of processing for moving data from the image forming apparatus 10 to a destination SD card according to the present embodiment. FIG. 6 is a sequence chart illustrating an example of the processing for moving the data from the image forming apparatus 10 to the destination SD card according to the present embodiment. FIGS. 5 and 6 are diagrams illustrating the same processing in different manners. In both drawings, the same or corresponding steps are denoted by the same step numbers.

In step S201, the movement control unit 122 receives an instruction to move the data from the eMMC 115 to the destination SD card from the operation control unit 121 that has received the instruction from the operator.

The movement control unit 122 checks whether the destination SD card satisfies conditions determined in advance (step S202). For example, the movement control unit 122 checks whether the destination SD card is inserted into the SD card slot 17, whether the license information is stored in the destination SD card, and whether valid (legitimate) application data is stored in the destination SD card. The license information and the application data stored in the destination SD card to be checked are different from those subjected to the movement. In the present embodiment, in order to prohibit the use of an unspecified SD card as the destination SD card, the destination SD card is limited to an SD card (an SD card purchased through a legitimate sales route) in which a valid application is stored in advance.

In a case where any one of the conditions is not satisfied (NO in step S203), the operation control unit 121 displays error information indicating that the condition is not satisfied on the control panel 15 (step S204), and ends the processing.

In a case where all of the conditions are satisfied (YES in step S203), the movement control unit 122 copies (stores) the license information stored in the eMMC 115 to (in) the destination SD card (step S205). More specifically, the movement control unit 122 requests the license management unit 123 to move the license information from the eMMC 115 to the destination SD card (step S205-1 in FIG. 6). The license management unit 123 acquires a list of file names of the application data and the license information stored in the eMMC 115 (steps S205-2 and S205-3 in FIG. 6). The license management unit 123 also acquires a list of file names of the application data and the license information stored in the destination SD card (steps S205-4 and S205-5 in FIG. 6).

The license management unit 123 checks whether there is an overlap between the list of file names acquired from the eMMC 115 and the list of file names acquired from the destination SD card to determine whether the data stored in the eMMC 115 has already been stored in the destination SD card. In a case where the license management unit 123 recognizes that there is an overlap between the list of file names acquired from the eMMC 115 and the list of file names acquired from the destination SD card (that is, in a case where the data stored in the eMMC 115 has already been stored in the destination SD card), the license management unit 123 transmits a notification indicating the failure of the movement of the license information to the movement control unit 122 without executing the subsequent processing.

In a case where the license management unit 123 recognizes that there is no overlap between the list of file names acquired from the eMMC 115 and the list of file names acquired from the destination SD card, the license management unit 123 copies the license information stored in the eMMC 115 (steps S205-6 and S205-7 in FIG. 6). The license management unit 123 stores the license information in the destination SD card (step S205-8). The license management unit 123 invalidates the license information stored in the eMMC 115 by, for example, deleting the license information stored in the eMMC 115 (step S205-9). When the license information stored in the eMMC 115 is successfully invalidated, the license management unit 123 transmits a notification indicating the success of the movement of the license information to the movement control unit 122.

When the license management unit 123 transmits the notification indicating the failure of the movement of the license information to the movement control unit 122 (NO in step S206), the operation control unit 121 displays error information indicating the failure of the movement of the license information on the control panel 15 (step S207), and ends the processing.

When the license management unit 123 transmits the notification indicating the success of the movement of the license information to the movement control unit 122 (YES in step S206), the movement control unit 122 copies (stores) the application data stored in the eMMC 115 to (in) the destination SD card (step S208).

In a case where the copying of the application data is not successfully completed (NO in step S209), the operation control unit 121 displays error information indicating that the copying of the application data is not successfully completed on the control panel 15 (step S210), and ends the processing. For example, when the capacity of the destination SD card is insufficient, the copying of the application data fails. In a case where the copying of the application data is successfully completed (YES in step S209), the operation control unit 121 displays information indicating that the copying of the application data is successfully completed on the control panel 15 (step S211), and ends the processing.

Next, a description is given of processing for cancelling the movement of the data (from the source SD card to the eMMC 115). When the copying of the application data fails in step S105 and the error information is displayed in step S107 as illustrated in FIG. 3, the operator needs to instruct a cancellation of the movement of the data from the source SD card to the eMMC 115. In addition, after the processing of FIG. 3 is successfully completed (after the information indicating the successful completion is displayed in step S110) and before the processing of FIG. 5 starts (before the movement of the data from the eMMC 115 to the destination SD card starts), the operator can instruct the cancellation of the movement of the data from the source SD card to the eMMC 115.

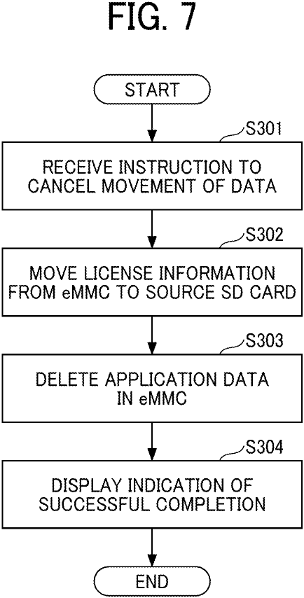

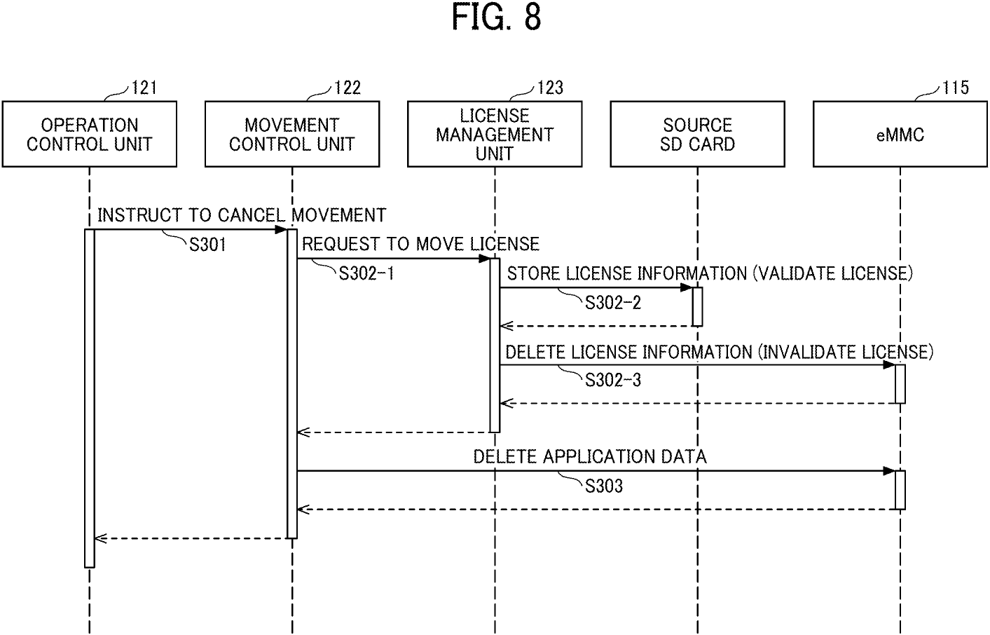

FIG. 7 is a flowchart illustrating an example of processing for cancelling the movement of the data from the source SD card to the image forming apparatus 10 according to the present embodiment. FIG. 8 is a sequence chart illustrating an example of the processing for cancelling the movement of the data from the source SD card to the image forming apparatus 10 according to the present embodiment. FIGS. 7 and 8 are diagrams illustrating the same processing in different manners. In both drawings, the same or corresponding steps are denoted by the same step numbers.

In step S301, the movement control unit 122 receives a cancel instruction to cancel the movement of the data from the source SD card to the eMMC 115 from the operation control unit 121 that has received the cancel instruction from the operator. Note that the source SD card needs to be inserted into the SD card slot 17 when the cancel instruction is input.

The image forming apparatus 10 moves the license information stored in the eMMC 115 to the source SD card (step S302). More specifically, the movement control unit 122 requests the license management unit 123 to move the license information from the eMMC 115 to the source SD card (step S302-1 in FIG. 8). The license management unit 123 copies (stores) the license information stored in the eMMC 115 to (in) the source SD card to validate the license information stored in the source SD card (step S302-2). In a case where the license information is not deleted from the source SD in, for example, S109, the validation of the license information in the source SD may be performed differently. In a case where the write protection is applied to the source SD card, the license management unit 123 releases the write protection and executes the processing of step S302-2 and subsequent steps. The license management unit 123 deletes the license information from the eMMC 115 to invalidate the license information stored in the eMMC 115 (S302-3).

In a case where the copying of the application data fails in step S105 of FIG. 3 and the movement of the data is cancelled, the processing of steps S302-1 and S302-2 does not need to be executed since the license information has not been moved from the source SD card to the eMMC 115.

The movement control unit 122 deletes the application data stored in the eMMC 115 (step S303). Note that even if the copying of the application data fails in step S105 of FIG. 3, in a case where there is data partially copied in the eMMC 115, the data is deleted.

The operation control unit 121 displays information indicating successful completion on the control panel 15 (step S304). By referring to this information, the operator recognizes that the source SD card and the eMMC 115 have returned to the states before the execution of the processing of FIG. 3.

After the processing of step S301, the movement control unit 122 may confirm that the SD card inserted into the SD card slot 17 is a legitimate source SD card, and then executes the processing of step S302 and subsequent steps. The legitimate source SD card refers to an SD card that is the true source of the license information and the application data temporarily stored in the eMMC 115. Whether the source SD card is a legitimate source SD card may be determined based on whether the application data stored in an SD card inserted into the SD card slot 17 matches the application data stored in the eMMC 115. That is, in a case where the two pieces of the application data coincide with each other, the SD card inserted into the SD card slot 17 is determined to be the legitimate source SD card.

As described above, according to the present embodiment, instead of copying data directly between the source SD card and the destination SD card, the data stored in the source SD card is temporarily moved to the memory included in the image forming apparatus 10, and then the data is moved from the memory to the destination SD card. Accordingly, even if a plurality of external recording media is not connected to the image forming apparatus 10 at the same time, the data can be moved between the plurality of external recording media. As a result, only one SD card slot 17 is required for the image forming apparatus 10, resulting in a reduction of the manufacturing cost. In addition, since the number of SD card slots 17 is reduced, the size of the image forming apparatus 10 can be reduced.

In the present embodiment, it is assumed that the data subjected to the movement is application data. However, the present embodiment may be applied to other data that is usable when the license information is attached, such as audio data and image data.

The external recording medium in which the data subjected to the movement is stored may be any suitable recording medium other than the SD card.

Any memory or storage device included in the image forming apparatus 10 other than the eMMC 115 may be used as a temporary storage area for the data. For example, the HDD 114 may be used as the temporary storage area for the data.

The present embodiment may be applied to any information processing apparatus, other than an image forming apparatus, having a memory or storage device and a connection port for connecting an external recording medium. The present embodiment may be applied to, for example, a projector, an interactive whiteboard (IWB; an electronic whiteboard having a blackboard function capable of mutual communication), an output device such as a digital signage, a head-up display (HUD) device, an industrial machine, an imaging device, a sound collecting device, a medical device, a network home appliance, a laptop personal computer (PC), a mobile phone, a smartphone, a tablet terminal, a game console, a personal digital assistant (PDA), a digital camera, a wearable PC, or a desktop PC.

In the present embodiment, the image forming apparatus 10 is an example of an information processing apparatus. The eMMC 115 is an example of a memory. The source SD card is an example of a first recording medium. The destination SD card is an example of a second recording medium. The movement control unit 122 is an example of a first movement control device and an example of a second movement control device. The license management unit 123 includes a first invalidation device, a second invalidation device, and a cancellation device. The operation control unit 121 is an example of an output device.

The above-described embodiment is illustrative and does not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An information processing apparatus comprising:
a memory;
a connection port configured to connect to an external recording medium including a first recording medium and a second recording medium; and
circuitry configured to:
store, in the memory, data and license information of the data read from the first recording medium connected to the connection port;
invalidate the license information stored in the first recording medium;
store the data and the license information read from the memory in the second recording medium that is connected to the connection port after the first recording medium has been disconnected from the connection port; and
invalidate the license information stored in the memory.

2. The information processing apparatus according to claim 1, wherein the circuitry is further configured to output, after invalidating the license information stored in the first recording medium, information indicating a request to disconnect the first recording medium from the connection port and connect the second recording medium to the connection port.

3. The information processing apparatus according to claim 1, wherein, after invalidating the license information stored in the first recording medium, the circuitry is configured to, in response to an input by a user, validate the license information stored in the first recording medium and delete the license information stored in the memory.

4. The information processing apparatus according to claim 1, wherein the circuitry is further configured to disable, after invalidating the license information stored in the first recording medium, writing to the first recording medium.

5. An information processing method comprising:
storing, in a memory, data and license information of the data read from a first recording medium connected to a connection port of an information processing apparatus;
invalidating the license information stored in the first recording medium;
storing the data and the license information read from the memory in a second recording medium that is connected to the connection port after the first recording medium has been disconnected from the connection port; and
invalidating the license information stored in the memory.

6. A non-transitory recording medium storing a plurality of program codes which, when executed by one or more processors, causes the processors to perform a method, the method comprising:
storing, in a memory, data and license information of the data read from a first recording medium connected to a connection port of an information processing apparatus;
invalidating the license information stored in the first recording medium;
storing the data and the license information read from the memory in a second recording medium that is connected to the connection port after the first recording medium has been disconnected from the connection port; and
invalidating the license information stored in the memory.
